(19) United States
(12) Patent Application Publication
(10) Pub. No.: US 2006/0130465 A1
(43) Pub. Date: Jun. 22, 2006

(54) Method and system for controlling exhaust gases emitted from an internal combustion engine

(75) Inventors: Min Sun, Windsor (CA); Zornitza Pavlinova Pavlova-MacKinnon, Farmington Hills, MI (US); Kevin Dean Sisken, Saline, MI (US)

Correspondence Address: BROOKS KUSHMAN P.C., 1000 TOWN CENTER, TWENTY-SECOND FLOOR, SOUTHFIELD, MI, 48075, US

(73) Assignee: Detroit Diesel Corporation, Detroit, MI (US)

(21) Appl. No.: 11/020,838

(22) Filed: Dec. 22, 2004

(51) Int. Cl. F02M 25/06; F01N 3/00

(52) U.S. Cl. 60/295; 60/285; 60/297; 60/278

(57) ABSTRACT

Method, system, and controller for controlling oxygen levels in exhaust gases as a function of soot burn rates of a particulate filter so as to facilitate regeneration of the particulate filter. The method, system, and controller being applicable in systems having an engine which emits exhaust gases having particulates which are captured by the particulate filter.

### BACKGROUND OF THE INVENTION

1. Field of the Invention

The present invention relates to systems and methods for controlling exhaust gases emitted from an internal combustion engine.

2. Background Art

A particulate filter is a device for capturing particulates emitted in exhaust gases from a combustion engine. In some systems employing a particulate filter, it may be desired to oxidize or burn the capture particulates in a process commonly referred to as regeneration. The regeneration of the particulates is dependent on temperatures at the particulate filter, which may be influence by exhaust gas oxygen concentration and/or exhaust gas temperatures.

Accordingly, a need exists to control oxygen concentration and/or exhaust gas temperatures so as to facilitate and/or control regeneration of particulates captured with the particulate filter.

### SUMMARY OF THE INVENTION

One non-limiting aspect of the present invention relates to controlling exhaust gas oxygen levels and/or exhaust gas temperatures to facilitate and/or control regeneration of a particulate filter.

In accordance with one non-limiting aspect of the present invention, a controller may be configured to determine desired exhaust gas oxygen levels and/or exhaust gas temperatures and to control system components in accordance therewith.

In accordance with one non-limiting aspect of the present invention, the exhaust gas oxygen levels may be determined as a function of soot burn rates of the particulate filter during regeneration such that the oxygen levels may be controlled to prevent uncontrolled regeneration of the particulate filter.

In accordance with one non-limiting aspect of the present invention, the exhaust gas oxygen levels may be controlled by controlling recirculation of exhaust gases to an engine emitting the exhaust gases. For example, exhaust gases may be recirculated to the engine through a cooled exhaust gas recirculation (EGR) passage having an EGR cooler and a EGR cooler bypass passage so as to control oxygen levels in the exhaust gases.

In accordance with one non-limiting aspect of the present invention, a desired exhaust gas temperature may be determine to facilitate regeneration of the particulate filter such that EGR through the cooler and cooler bypass may be controller as function thereof in order to achieve and maintain the desired exhaust gas temperature.

The above features and advantages, along with other features and advantages of the present invention, are readily apparent from the following detailed description of the invention when taken in connection with the accompanying drawings

### BRIEF DESCRIPTION OF THE DRAWINGS

FIG. 1 a system in accordance with one non-limiting aspect of the present invention.

### DETAILED DESCRIPTION OF THE PREFERRED EMBODIMENT(S)

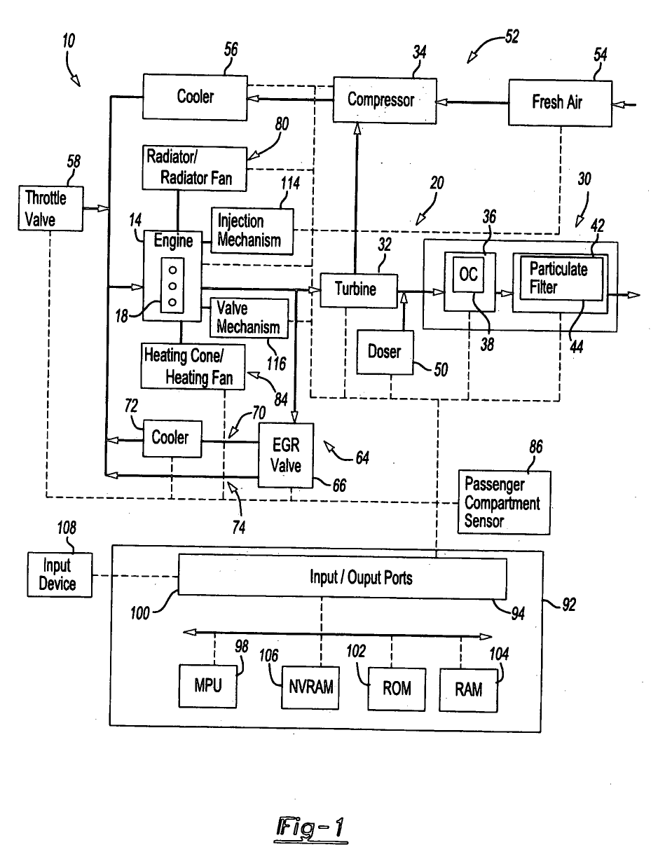

FIG. 1 illustrates a vehicle powertrain system 10 in accordance with one non-limiting aspect of the present invention. The system 10 may provide power for driving any number of vehicles, including on-highway trucks, construction equipment, marine vessels, stationary generators, automobiles, trucks, tractor-trailers, boats, recreational vehicle, light and heavy-duty work vehicles, and the like.

The system 10 may be referred to as an internal combustion driven system wherein fuels, such as gasoline and diesel fuels, are burned in a combustion process to provide power, such as with an spark or compression ignition engine 14. The engine 14 may be a diesel engine that includes a number of cylinders 18 into which fuel and air are injected for ignition as one skilled in the art will appreciate. The engine 14 may be a multi-cylinder compression ignition internal combustion engine, such as a 4, 6, 8, 12, 16, or 24 cylinder diesel engines, for example. It should be noted, however, that the present invention is not limited to a particular type of engine or fuel.

Exhaust gases generated by the engine 14 during combustion may be emitted through an exhaust system 20. The exhaust system 20 may include any number of features, including an exhaust manifold and passageways to deliver the emitted exhaust gases to a particulate filter assembly 30, which in the case of diesel engines is commonly referred to as a diesel particulate filter. Optionally, the system 20 may include a turbocharger proximate the exhaust manifold for compressing fresh air delivery into the engine 14. The turbocharger, for example, may include a turbine 32 and a compressor 34, such as a variable geometry turbocharger (VGT) and/or a turbocompound power turbine. Of course, the present invention is not limited to exhaust systems having turbochargers or the like.

The particulate filter assembly 30 may be configured to capture particulates associated with the combustion process. In more detail, the particulate filter assembly 30 may include an oxidation catalyst (OC) canister 36, which in includes an OC 38, and a particulate filter canister 42, which includes a particulate filter 44. The canisters 36, 42 may be separate components joined together with a clamp or other feature such that the canisters 36, 42 may be separated for servicing and other operations. Of course, the present invention is not intended to be limited to this exemplary configuration for the particulate filter assembly 30. Rather, the present invention contemplates the particulate filter assembly including more or less of these components and features. In particular, the present invention contemplates the particulate filter assembly 30 including only the particulate filter 44 and not necessarily the OC canister 36 or substrate 38 and that the particulate filter 44 may be located in other portions of the exhaust system 20, such as upstream of the turbine 32.

The OC 38, which for diesel engines is commonly referred to as a diesel oxidation catalyst, may oxidize hydrocarbons and carbon monoxide included within the exhaust gases so as to increase temperatures at the particulate filter 44. The particulate filter 44 may capture particulates included within the exhaust gases, such as carbon, oil particles, ash, and the like, and regenerate the captured particulates if temperatures associated therewith are sufficiently high. In accordance with one non-limiting aspect of the present invention, one object of the particulate filter assembly 30 is to capture harmful carbonaceous particles included in the exhaust gases and to store these contaminates until temperatures at the particulate filter 44 favor oxidation of the captured particulates into a gas that can be discharged to the atmosphere.

The OC and particulate filter canisters 36, 42 may include inlets and outlets having defined cross-sectional areas with expansive portions therebetween to store the OC 38 and particulate filter 44, respectively. However, the present invention contemplates that the canisters 36, 42 and devices therein may include any number configurations and arrangements for oxidizing emissions and capturing particulates. As such, the present invention is not intended to be limited to any particular configuration for the particulate filter assembly 30.

To facilitate oxidizing the capture particulates, a doser 50 may be included to introduce fuel to the exhaust gases such that the fuel reacts with the OC 38 and combusts to increase temperatures at the particulate filter 44, such as to facilitate regeneration. For example, one non-limiting aspect of the present invention contemplates controlling the amount of fuel injected from the doser as a function of temperatures at the particulate filter 44 and other system parameters, such as air mass flow, EGR temperatures, and the like, so as to control regeneration. However, the present invention also contemplates that fuel may be included within the exhaust gases through other measures, such as by controlling the engine 14 to emit fuel with the exhaust gases.

An air intake system 52 may be included for delivering fresh air from a fresh air inlet 54 through an air passage to an intake manifold for introduction to the engine 14. In addition, the system 52 may include an air cooler or charge air cooler 56 to cool the fresh air after it is compressed by the compressor 34. Optionally, a throttle intake valve 58 may be provided to control the flow of fresh air to the engine 14. The throttle valve 58 may be a manually or electrically operated valve, such as one which is responsive to a pedal position of a throttle pedal operated by a driver of the vehicle. There are many variations possible for such an air intake system and the present invention is not intended to be limited to any particular arrangement. Rather, the present invention contemplates any number of features and devices for providing fresh air to the intake manifold and cylinders, including more or less of the foregoing features.

An exhaust gas recirculation (EGR) system 64 may be optionally provided to recycle exhaust gas to the engine 14 for mixture with the fresh air. The EGR system 64 may selectively introduce a metered portion of the exhaust gasses into the engine 14. The EGR system 64, for example, may dilute the incoming fuel charge and lower peak combustion temperatures to reduce the amount of oxides of nitrogen produced during combustion. The amount of exhaust gas to be recirculated may be controlled by controlling an EGR valve 66 and/or in combination with other features, such as the turbocharger. The EGR valve 66 may be a variable flow valve that is electronically controlled. There are many possible configurations for the controllable EGR valve 66 and embodiments of the present invention are not limited to any particular structure for the EGR valve 66.

The EGR system 64 in one non-limiting aspect of the present invention may include an EGR cooler passage 70, which includes an air cooler 72, and an EGR non-cooler bypass 74. The EGR value 66 may be provided at the exhaust manifold to meter exhaust gas through one or both of the EGR cooler passage 70 and bypass 74. Of course, the present invention contemplates that the EGR system 64 may include more or less of these features and other features for recycling exhaust gas. Accordingly, the present invention is not intended to be limited to any one EGR system and contemplates the use of other such systems, including more or less of these features, such as an EGR system having only one of the EGR cooler passage or bypass.

A cooling system 80 may be included for cycling the engine 14 by cycling coolant therethrough. The coolant may be sufficient for fluidly conducting away heat generated by the engine 14, such as through a radiator. The radiator may include a number of fins through which the coolant flows to be cooled by air flow through an engine housing and/or generated by a radiator fan directed thereto as one skilled in the art will appreciated. It is contemplated, however, that the present invention may include more or less of these features in the cooling system 80 and the present invention is not intended to be limited to the exemplary cooling system described above.

The cooling system 80 invention may operate in conjunction with a heating system 84. The heating system 84 may include a heating cone, a heating fan, and a heater valve. The heating cone may receive heated coolant fluid from the engine 14 through the heater valve so that the heating fan, which may be electrically controllable by occupants in a passenger area or cab of a vehicle, may blow air warmed by the heating cone to the passengers. For example, the heating fan may be controllable at various speeds to control an amount of warmed air blown past the heating cone whereby the warmed air may then be distributed through a venting system to the occupants. Optionally, sensors and switches 86 may be included in the passenger area to control the heating demands of the occupants. The switches and sensors may include dial or digital switches for requesting heating and sensors for determining whether the requested heating demand was met. The present invention contemplates that more or less of these features may be included in the heating system and is not intended to be limited to the exemplary heating system described above.

A controller 92, such as an electronic control module or engine control module, may be included in the system 10 to control various operations of the engine 14 and other system or subsystems associated therewith, such as the sensors in the exhaust, EGR, and intake systems. Various sensors may be in electrical communication with the controller via input/output ports 94. The controller 92 may include a microprocessor unit (MPU) 98 in communication with various computer readable storage media via a data and control bus 100. The computer readable storage media may include any of a number of known devices which function as read only memory 102, random access memory 104, and non-volatile random access memory 106. A data, diagnostics, and programming input and output device 108 may also be selectively connected to the controller via a plug to exchange various information therebetween. The device 108 may be used to change values within the computer readable storage media, such as configuration settings, calibration variables, instructions for EGR, intake, and exhaust systems control and others.

The system 10 may include an injection mechanism 114 for controlling fuel and/or air injection for the cylinders 18. The injection mechanism 114 may be controlled by the controller 92 or other controller and comprise any number of features, including features for injecting fuel and/or air into a common-rail cylinder intake and a unit that injects fuel and/or air into each cylinder individually. For example, the injection mechanism 114 may separately and independently control the fuel and/or air injected into each cylinder such that each cylinder may be separately and independently controlled to receive varying amounts of fuel and/or air or no fuel and/or air at all. Of course, the present invention contemplates that the injection mechanism 114 may include more or less of these features and is not intended to be limited to the features described above.

The system 10 may include a valve mechanism 116 for controlling valve timing of the cylinders 18, such as to control air flow into and exhaust flow out of the cylinders 18. The valve mechanism 116 may be controlled by the controller 92 or other controller and comprise any number of features, including features for selectively and independently opening and closing cylinder intake and/or exhaust valves. For example, the valve mechanism 116 may independently control the exhaust valve timing of each cylinder such that the exhaust and/or intake valves may be independently opened and closed at controllable intervals, such as with a compression brake. Of course, the present invention contemplates that the valve mechanism may include more or less of these features and is not intended to be limited to the features described above.

In operation, the controller 92 receives signals from various engine/vehicle sensors and executes control logic embedded in hardware and/or software to control the system 10. The computer readable storage media may, for example, include instructions stored thereon that are executable by the controller 92 to perform methods of controlling all features and sub-systems in the system 10. The program instructions may be executed by the controller in the MPU 98 to control the various systems and subsystems of the engine and/or vehicle through the input/output ports 94. In general, the dashed lines shown in FIG. 1 illustrate the optional sensing and control communication between the controller and the various components in the powertrain system. Furthermore, it is appreciated that any number of sensors and features may be associated with each feature in the system for monitoring and controlling the operation thereof.

In one non-limiting aspect of the present invention, the controller 92 may be the DDEC controller available from Detroit Diesel Corporation, Detroit, Mich. Various other features of this controller are described in detail in a number of U.S. patents assigned to Detroit Diesel Corporation. Further, the controller may include any of a number of programming and processing techniques or strategies to control any feature in the system 10. Moreover, the present invention contemplates that the system may include more than one controller, such as separate controllers for controlling system or sub-systems, including an exhaust system controller to control exhaust gas temperatures, mass flow rates, and other features associated therewith. In addition, these controllers may include other controllers besides the DDEC controller described above.

In accordance with one non-limiting aspect of the present invention, the controller 92 or other feature, such as regeneration system controller, may be configured for determining a desired soot burn rate for the particulate filter 44 to facilitate regeneration of the particulate filter 44 whereby particulates captured by the particulate filter 44 are oxidized or otherwise burned. The disposal of the particulates in this manner may be advantageous to prevent clogging and filling of the particulate filter 44 so that the exhaust gases may pass therethrough with minimal restriction and yet permit additional particulates to be collected.

The desired soot burn rate may be calculated to correspond with other factors and influences on the regeneration process. For the purposes of the present invention, the desired soot burn rate is intended to refer to a desired rate or range of rates at which oxidation of particulates captured by the particulate filter should occur. The desired soot burn rate may be a function of the particulate filter material and geometric properties and preferably selected to correspond with a maximize rate at which the particulates may be oxidized before an uncontrolled oxidation or soot burn condition occurs, which generally occurs when the rate of oxidation causes the particulate filter temperatures to rise faster than the particulate filter may be cooled such that the rising temperatures begin to approach those associated with particulate filter damage. Because it is often more desirable to oxidize the particulates as rapidly as possible and particulates oxidize faster at higher temperatures, the desired soot burn rate may closely approach the soot burn rates associated with uncontrolled regeneration. Of course, however, the present invention contemplates any number of parameters may be considered in determining the desired soot burn rates, and in particular, that other regeneration related features and parameters, such as exhaust gas temperatures, exhaust gas flow rate, and the like, may be considered.

One non-limiting aspect of the present invention relates to controlling oxygen levels in the exhaust gases emitted from the engine 14 to prevent the uncontrolled soot burn condition. The control thereof may be instigated according to software included on the controller 92 or inputted thereto. Similarly, however, the control may be executed with other logic and other controllers, such as a regeneration system controller or the like.

In one non-limiting aspect of the present invention, the oxygen levels in the exhaust gases emitted form the engine 14 are controlled by controlling an amount of exhaust gases recirculated to the engine 14 through one or both the EGR cooler passage 70 and EGR cooler bypass 74. For example, the amount of recirculated exhaust gas may be controlled as a function of the particulate filter burn rates such that oxygen levels are increased if the soot burn rate is less than the desired soot burn rate and decreased if the soot burn rate is greater than or anticipated to exceed the desired soot burn rate. In more detail, exhaust gas may be recirculated through the EGR cooler passage 70 to decrease oxygen content in the exhaust gases emitted from the engine and recirculated through the EGR cooler bypass 74 to increase oxygen content in the exhaust gases emitted from engine. Likewise, however, the recirculated exhaust gases may be modulated or mixed between the EGR cooler passage 70 and bypass 74 to control the oxygen levels.

In one non-limiting aspect of the present invention, the particulate filter soot burn rate may be preferably monitored by the controller 92 or other feature in the system to provide a feedback factor for adjusting the oxygen levels in the exhaust gases. In more detail, the controller 92 may be programmed or otherwise instructed to determine the soot burn rate of the particulate filter 44 as a function of particulate filter temperature, which may be determined by a virtual sensor, particulate filter sensor, or other sensor in the particulate filter canister 42 or in communication therewith, and based on this temperature, to control the exhaust gases recirculated to the engine. Optionally, the oxygen levels may be further controlled by combining control of the recirculated exhaust gases with other features in the system, engine speed control, throttle valve control, and fresh air compressor control.

In one non-limiting aspect of the present invention, exhaust gas through the cooler 70 and cooler bypass 74 may be controlled as a function of low temperature condition for the exhaust gases. In more detail, the low temperature condition may correspond to low exhaust gas temperatures, such as those below 250° C. In accordance with one non-limiting aspect of the present invention, the EGR is delivered through the bypass 74 such that subsequent combustion produces exhaust gases at elevate exhaust gas temperatures due to the recycled, non-cooled exhaust gases.

In one non-limiting aspect of the present invention, the flow of exhaust gas through the cooler 70 and cooler bypass 74 may be controlled as a function of exhaust gas temperature. For example, the desired exhaust gas temperature may be determined to facilitate regeneration of the particulate filter 44 such that exhaust gas is recirculated through the cooler 70 to increase exhaust gas temperatures and exhaust gas is recirculated through the cooler bypass 74 to decrease exhaust gas temperatures.

In one non-limiting aspect of the present invention, the flow of exhaust gas through the cooler 70 and cooler bypass 74 may be controlled as a function of both desired exhaust gas temperature and exhaust gas oxygen levels. For example, recirculation may be controlled as a function of desired exhaust gas temperatures to facilitate regeneration of the particulate filter and limited according to desired oxygen levels so as to prevent uncontrolled soot burn.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for controlling oxygen levels in exhaust gases emitted from an internal combustion engine having a particulate filter in fluid communication with the emitted exhaust gases to capture particulates, the method comprising:
controlling oxygen levels in the exhaust gases as a function of a soot burn rate of the particulate filter during regeneration by controlling an amount of cooled exhaust gas recirculated to the engine from an exhaust gas recirculation (EGR) cooled passage, the cooled passage having an air cooler to cool the recirculated exhaust gases.

2. The method of claim 1 wherein the amount of exhaust gases recirculated to the engine through the EGR cooled passage is increased to decrease the oxygen levels in the exhaust gases and decreased to increase the oxygen levels in the exhaust gases.

3. The method of claim 1 wherein the amount of exhaust gases recirculated to the engine is controlled by controlling a flow rate of the recirculated exhaust gases.

4. The method of claim 1 further comprising controlling an amount of non-cooled exhaust gas recirculated to the engine through an EGR air cooler bypass in combination with controlling the amount of cooled exhaust gas recirculated to the engine through the EGR cooled passage to control the oxygen levels in the exhaust gases.

5. The method of claim 4 further comprising recirculating more exhaust gases from the EGR cooler bypass than the EGR cooler to increase oxygen levels in the exhaust gases and recirculating less exhaust gases from the EGR air cooler bypass than the EGR cooler to decrease oxygen levels in the exhaust gases.

6. The method of claim 4 further comprising controlling the amount of exhaust gases from the EGR air cooler and the EGR air cooler bypass in addition to a throttle valve to control the oxygen levels in the exhaust gases, wherein the throttle valve controls fresh air delivered to the engine.

7. The method of claim 1 further comprising decreasing oxygen levels in the exhaust gases if the soot burn rate indicates an uncontrolled soot burn condition.

8. The method of claim 6 further comprising determining the uncontrolled soot burn condition if the soot burn rate is greater than a predefined soot burn rate value.

9. A method for controlling oxygen levels in exhaust gases emitted from an internal combustion engine to prevent an uncontrolled soot burn condition in a particulate filter during regeneration, the particulate filter being in fluid communication with the emitted exhaust gases to capture particulates, the method comprising:
monitoring soot burn rates of the particulate filter during regeneration; and
controlling oxygen levels in the exhaust gases as a function of the soot burn rates so as to prevent the uncontrolled soot burn condition by controlling an amount of cooled and non-cooled exhaust gas recirculated to the engine through an exhaust gas recirculation (EGR) cooled passage and a EGR cooler bypass.

10. The method of claim 9 wherein monitoring the soot burn rates includes determining a temperature of the particulate filter and calculating the soot burn rates as a function of the particulate filter temperature.

11. The method of claim 10 further comprising determining the uncontrolled soot burn condition if the soot burn rate is greater than a predefined soot burn rate value.

12. The method of claim 9 further comprising recirculating more exhaust gases from the EGR cooler bypass than the EGR cooler to increase oxygen levels in the exhaust gases and recirculating less exhaust gases from the EGR air cooler bypass than the EGR cooler to decrease oxygen levels in the exhaust gases.

13. A method of controlling exhaust gas temperatures of exhaust gases emitted from an internal combustion engine having a particulate filter in fluid communication with the emitted exhaust gases to capture particulates and an exhaust gas recirculation (EGR) cooler and cooler bypass in communication therewith for respecting recirculating cooled and non-cooled exhaust gases thereto, the method comprising:
determining a desired exhaust gas temperature; and
controlling exhaust gas recirculation through the EGR cooler and cooler bypass as a function of the desired exhaust gas temperature.

14. The method of claim 13 further comprising determining a low temperature condition for the exhaust gases and controlling recirculation through only the EGR cooler bypass until the low temperature condition ceases, and thereafter, controlling exhaust gas recirculation as a function of the desired exhaust gas temperature.

15. The method of claim 14 further comprising controlling exhaust gas recirculation as a function of exhaust gas oxygen levels and independent of the desired exhaust gas temperature if an uncontrolled soot burn condition is determined for the particulate filter.

16. The method of claim 13 further comprising determining the desired exhaust gas temperature as a function of soot burn rates of the particulate filter during regeneration.

17. The method of claim 15 further comprising determining a temperature of the particulate filter and calculating the soot burn rates as a function of the particulate filter temperature.

18. The method of claim 15 further comprising determining a uncontrolled soot burn condition if the soot burn rate is greater than a predefined soot burn rate value and controlling exhaust gas recirculation through only the EGR cooler if the uncontrolled soot burn condition is determined.

19. The method of claim 13 further comprising recirculating more exhaust gases from the EGR cooler bypass than the EGR cooler to increase oxygen levels in the exhaust gases and recirculating less exhaust gases from the EGR air cooler bypass than the EGR cooler to decrease oxygen levels in the exhaust gases.

20. The method of claim 13 further comprising controlling the amount of cooled and non-cooled exhaust gases recirculated by controlling a valve and/or controlling the amount of exhaust gases recirculated to the engine by controlling a flow rate of the recirculated exhaust gases.
